(19) United States
(12) Patent Application Publication
(10) Pub. No.: US 2006/0273758 A1
(43) Pub. Date: Dec. 7, 2006

(54) Battery pack

(75) Inventors: Yasushi Sanada, Yokohama-Shi (JP); Yoshinao Tatebayashi, Yokohama-Shi (JP); Nobuo Shibuya, Hiratsuka-Shi (JP); Shinichiro Kosugi, Yokohama-Shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-Ku (JP)

(21) Appl. No.: 11/444,492

(22) Filed: Jun. 1, 2006

(30) Foreign Application Priority Data
Jun. 2, 2005 (JP) 2005-162430

(51) Int. Cl. H02J 7/00

(52) U.S. Cl. 320/107

(57) ABSTRACT

A battery pack includes: a plurality of flat-shaped cells each including a generator element sealed by a laminate film; a case for accommodating the cells so as to be laminated in a thickness direction thereof, the case having an opening formed at least at one end thereof; a lid member fixed to the opening of the case and pressing the laminated cells in a laminating direction thereof; a bottom member provided between the case and the cell located at an end of the laminated cells on a side opposite to the opening of the case; a first tray provided between the cells and brought into contact with the case; a second tray provided between the lid member and the cells and brought into contact with the case; and a third tray provided between the bottom member and the cells and brought into contact with the case. The lid member and the bottom member are formed of a material having a thermal conductivity lower than a thermal conductivity of any one of the first tray, the second tray and the third tray.

### BACKGROUND OF THE INVENTION

1. Field of the Invention

The present invention relates to a battery pack of an assembled battery composed of a plurality of laminated cells sheathed with a laminate film. In particular, the present invention relates to a battery pack of an assembled battery which allows a reduction in temperature variations between cells within the battery pack.

2. Description of the Related Art

A conventional battery pack is composed of one cell. Such a battery pack is of a small capacity and its use is often limited to applications involving relatively little vibration or impact. In recent years, lightweight and compact, yet high-capacity, assembled batteries composed of a plurality of cells, such as a lithium battery, have been developed for use in portable cordless devices, automobiles, and the like.

In such a large-capacity assembled battery such as a lithium battery (which may be merely called “battery” hereinlater), a plurality of thin, flat-shaped cells are laminated so as to obtain a predetermined output.

It is known that in such an assembled battery, temperature variations occur due to the Joule heat and the chemical reaction heat generated inside the cells at the time of charging/discharging of the battery, causing variations in overdischarge/overcharge potential.

Further, in the case of an assembled battery using a plurality of cells as described above, when the cells are in different temperature states, the respective cells have different overdischarge and discharge potentials.

As a result, when charging the battery, the charge capacity is limited due to the presence of a cell having a low overcharge potential, which makes it impossible for a cell having a higher overcharge potential to store a sufficient electric power. Further, at the time of discharging, the discharge capacity is limited due to the presence of a cell having a high overdischarge potential, which causes the electric power that is not outputted to remain in a cell with a low overdischarge potential.

Thus, not only does the absolute amount of electric power that can be stored in the battery decrease, but also it becomes impossible to effectively extract all of the electric power stored in the battery.

Accordingly, in conventional assembled batteries, positive and negative electrode terminals are led out in at least three directions from a sealed outer peripheral edge portion, whereby terminals that generate heat are distributed in a scattered fashion to prevent temperature non-uniformity within each cell (see, for example, Japanese Patent Application Laid-open Publication No. 2004-47239).

However, the temperature non-uniformity preventing means as disclosed in the above publication is aimed at achieving a uniform temperature distribution within each individual cell through scattered distribution of the terminals that generate heat. The disclosure of the publication does not suggest any technique for reducing temperature variations between cells in an assembled battery composed of a large number of cells.

### SUMMARY OF THE INVENTION

The present invention has been conceived in consideration of the above circumstances encountered in the prior art mentioned above, and an object of the present invention is to provide a battery pack of an assembled battery which allows a reduction in temperature variations between respective cells within the battery pack.

In order to attain the above-mentioned object, according to one aspect of the present invention, there is provided a battery pack including: a plurality of flat-shaped cells each including a generator element sealed by a laminate film; a case for accommodating the cells so as to be laminated in a thickness direction thereof, the case having an opening formed at least at one end thereof; a lid member fixed to the opening of the case and pressing the laminated cells in a laminating direction thereof; a bottom member provided between the case and the cell located at an end of the laminated cells on a side opposite to the opening of the case; a first tray provided between the cells and brought into contact to the case; a second tray provided between the lid member and the cells and brought into contact to the case; and a third tray provided between the bottom member and the cells and brought into contact to the case, in which the lid member and the bottom member are formed of a material having a thermal conductivity lower than a thermal conductivity of any one of the first tray, the second tray and the third tray.

In preferred embodiments or examples of the above aspect, the first tray may be formed of a material having a thermal conductivity higher than a thermal conductivity of either one of the second tray and the third tray.

A thickness or a thickness-wise sectional configuration of the first tray may be varied so that the first tray has a thermal resistance lower than a thermal resistance of either one of the second tray and the third tray.

It is desirable that each of the first tray, the second tray and the third tray includes a contact part for guiding at least a placing position for each of the cells, the contact part being brought into press contact to opposite inner wall surfaces of the case.

It is also desirable that each of the first tray, the second tray and the third tray is formed in a configuration curved in a thickness direction in which the cells are laminated.

As has been described above, according to the present invention, in the battery composed of a laminate of cells respectively placed on the trays, heat of respective cells is conducted to the trays, the trays are brought into press contact to the inner wall surface of the case to thereby conduct the heat from the respective cells to the case, the thermal resistance paths are formed so as to release heat from each of the cells to the atmosphere from the outer wall of the case, and the amounts of heat release from the respective cells per unit time are made the same by varying the thermal resistance paths formed by the trays and the case in accordance with the laminating positions of the laminated cells, thereby making it possible to provide a battery pack with reduced temperature variations between cells within the batter pack.

The nature and further characteristic features of the present invention may be made clear from the following descriptions made with reference to the accompanying drawings.

### BRIEF DESCRIPTION OF THE DRAWINGS

In the accompanying drawings:

FIG. 1 is an exploded perspective view of a battery pack according to a first embodiment of the present invention;

FIGS. 2A and 2B are illustrations showing an outer appearance of a tray on which a cell is placed according to the first embodiment of the present invention;

FIG. 3 is an illustration showing an outer appearance of trays on which a plurality of cells are placed according to the fist embodiment of the present invention;

FIGS. 4A and 4B are sectional views illustrating the structure of the tray according to the first embodiment of the present invention;

FIG. 5 is a sectional view of the battery pack, illustrating how thermal conduction takes place according to the first embodiment of the present invention;

FIGS. 6A to 6C are views illustrating the structure of trays in a battery pack according to a second embodiment 2 of the present invention; and

FIG. 7 is a view showing a structure of a conventional flat-shaped lithium cell battery.

### DESCRIPTION OF THE PREFERRED EMBODIMENTS

Preferred embodiments of the present invention will be described hereunder with reference to the drawings. It is first to be noted that terms “upper”, “lower”, “right”, “left” and the like terms are used herein with reference to the illustrations of the drawings or in a generally usable state of the invention.

### First Embodiment

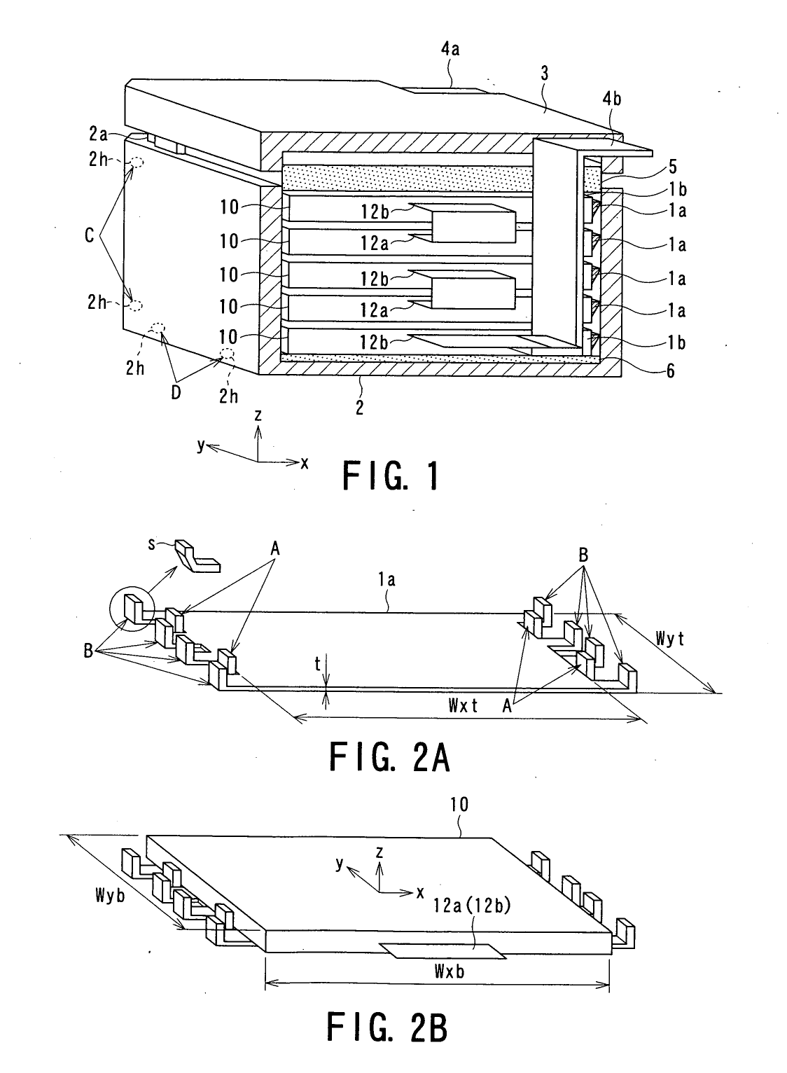

The first embodiment of the present invention will be first described hereunder with reference to FIGS. 1 to 5 and FIG. 7. FIG. 1 is an exploded perspective view of a battery pack of a battery used in a portable cordless device, an automobile, and the like, as viewed in section taken along one side surface of a case 2 of the battery pack, with a cover 3 of the case 2 being detached in a lifted manner.

A battery pack of a battery according to the present invention is composed of: an assembled battery 1 composed of a plurality of flat-shaped cells 10 laminated in the z-axis direction; the case 2 for accommodating the battery 1, which may be merely called “battery” hereinafter; a battery terminal 4a and a battery terminal 4b for connecting a positive electrode terminal 12a and a negative electrode terminal 12b of each cell 10 of the assembled battery 1, and leading them to the outside of the case 2; a lid member 5 that is fitted inside the case 2 and presses the surface of the uppermost cell 10 of the battery 1; and a bottom member 6 provided at the bottom portion of the case 2.

Further, the assembled battery 1 includes first trays 1a (hereinafter, referred to as the tray 1a) laminated between the cells 10, a second tray 1b (hereinafter, referred to as the tray 1b) placed on the uppermost cell 10, and a third tray 1c (hereinafter, referred to as the tray 1c) on which the lowermost cell 10 is placed.

Next, the structures of the respective portions will be described. Each cell 10 such as a lithium battery (herein, a battery cell provided with a pair of positive and negative electrode terminals and constituting the minimum output unit of a battery is referred to as the cell) is constructed as follows.

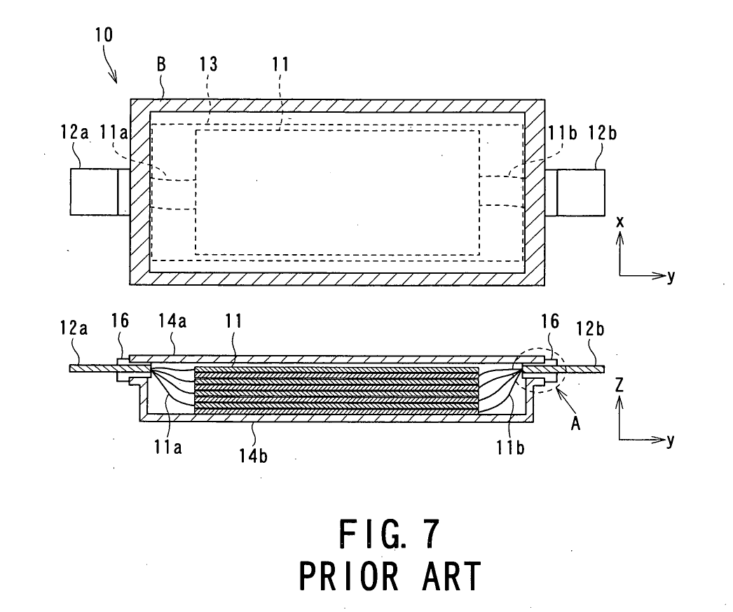

As shown in FIG. 7, each cell 10 is constructed such that its outer peripheral edge portion B is subjected to fusion bonding by sheet-like hermetic sealing means composed of an upper laminate film 14a and a lower laminate film 14b, thus sealing, inside the resultant structure, a plurality of generator elements 11 each including a generator element terminal 11a, a generator element terminal 11b, and electrolyte, not shown, which are laminated in the vertical axis (z-axis) direction. The positive electrode terminals 12a and the negative electrode terminals 12b, which are connected to the generator elements 11, are led out from the opposite ends of the sealed outer peripheral edge portion B with respect to the x-axis direction.

The upper laminate film 14a and the lower laminate film 14b each is composed of a composite film material having a heat-seal resin film located at the innermost layer, a metal foil such as an aluminum foil, and an organic resin film having rigidity, which are laminated in the described order.

Examples of the heat-seal resin film that can be used include a polyethylene (PE) film, a polypropylene (PP) film, a polypropylene-polyethylene copolymer film, an ionomer film, and an ethylene vinylacetate (EVA) film. Further, examples of the organic resin film having rigidity that can be used include a polyethylene terephthalate (PET) film and a nylon film.

The electrode terminal portion A of the cell 10 is subjected to heat sealing in alignment with the other outer peripheral edge portion, with a sealant 16 made of polyethylene or the like being sandwiched between the upper laminate film 14a and the lower laminate film 14b which serve to maintain the sealing property, thereby effecting sealing so that no electrolyte leakage occurs.

The sealant 16 as described above is preferably formed of an insulating resin film of a multi-layer structure exhibiting different characteristics between its surface opposed to the electrode terminals and the surface opposed to the upper laminate film 14a and the lower laminate film 14b.

For example, in the case of an insulating resin film having a two-layer structure, it is preferred that (i) the insulating resin film is composed of an acid-denatured polyethylene layer and a polyethylene layer, with the acid-denatured polyethylene layer being arranged on the side in contact with the electrode terminal 12 or (ii) the insulating resin film is composed of an acid-denatured polypropylene layer and a polypropylene layer, with the acid-denatured polypropylene layer being arranged on the side in contact with the electrode terminal 12.

For example, in the case of an insulating resin film having a three-layer structure, it is preferred that (i) a polyethylene layer is arranged at the intermediate layer, with an acid-denatured polyethylene layer being arranged on either side of the polyethylene layer or (ii) a polypropylene layer is arranged at the intermediate layer, with an acid-denatured polypropylene layer being arranged on either side of the polypropylene layer.

The acid-denatured polyethylene to be used is preferably acid-denatured low-density straight-chain polyethylene or acid-denatured straight-chain polyethylene, for example.

Further, it is preferred that the polyethylene to be used is, for example, intermediate-density or high-density polyethylene.

Further, it is preferred that the polypropylene to be used is, for example, homopolymer-based polypropylene.

Further, it is preferred that the acid-denatured polypropylene to be used is, for example, random copolymer-based polypropylene.

When assembling the cells 10 into the battery 1, the number of the cells 10 and the connection of the cells, i.e. in series or parallel, are set in advance on the basis of the required electric capacitance and voltage.

Further, in each of the flat-shaped, thin cells 10, the generator elements 11 including electrolyte are hermetically sealed by the laminate films 14a and 14b each composed of an integrated polymer-based sealant having a reinforcing material such as a metal layer or a synthetic resin layer interposed therein.

Further, the case 2 is normally made from a metal having good thermal conductivity, such as aluminum.

Next, referring to FIGS. 2A to 4B, the trays 1a, 1b, and 1c, on which the respective cells 10 are placed, will be described. Here, the tray 1b placed on the uppermost cell 10 of the assembled battery 1 and the tray 1c, on which the lowermost cell 10 of the battery 1 is placed, differ from each other only in whether the cell 10 is placed on the tray or the tray is placed on the cell 10 and they can be regarded as identical with each other in terms of the heat release action of the thermal resistance path. Therefore, the following description will focus on the case of only one of the tray 1b and the tray 1c.

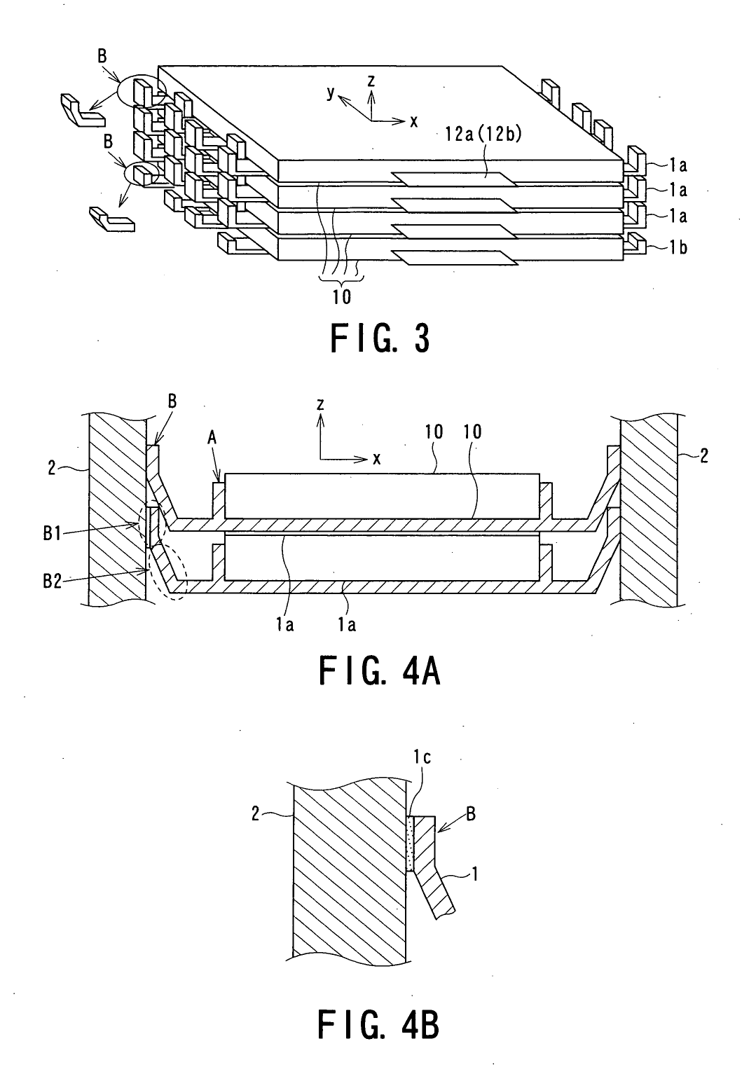

FIGS. 2A and 2B are views of the tray 1a, showing each cell 10, three trays 1a, and one third tray 1c when a plurality of the cells 10 are laminated. Further, FIGS. 4A and 4B are partial sectional views, taken along x-z plain in FIG. 3, of a positioning part A and a contact part B of the first tray 1a.

A plurality of the contact parts B are provided at both end portions of the tray 1a while being opposed to each other. Further, as shown in FIG. 4A, each contact part B is composed of a contact portion B1 that contacts each of the opposing inner wall surfaces of the case 2, and a bent portion B2. Although, in FIGS. 2 and 3, the contact part B is depicted as being L-shaped, more specifically, the contact part B surrounded by the circle has a shape formed by the contact portion B1 and the bent portion B2 as shown in the perspective view indicated by the arrow in FIG. 4A.

The description will now be given of the principle of thermal conduction in the battery pack according to the present invention using the tray 1a provided with such contact parts B and the tray 1c.

The tray 1a and the tray 1c form, respectively, a thermal resistance path for transferring the heat of each cell 10 to the case 2. The thermal resistance of the thermal resistance path is composed of a thermal resistance determined by the material and configuration of the thermal conduction path of each of the trays 1a and 1c, and a contact thermal resistance with the contact parts B provided in each of the trays 1a and 1c which will be described later.

The principle of the thermal conduction is such that the thermal resistances of the thermal resistance paths formed by the trays 1a and 1c, on which the respective cells 10 laminated at different positions are placed, are varied so that the amounts of heat released from the respective cells 10 become the same, thereby suppressing the variations in temperature among the respective cells 10 to achieve uniform temperature.

Next, the structure of the trays 1a and 1c will be described in detail. Each of the trays 1a and 1c is formed from a material with a large thermal conductivity, such as metal, and has, at the ends of its flat-shaped portion, the positioning parts A for determining the position at which the cell 10 is to be placed, and the contact parts B which are brought into press contact with the inner side wall of the case 2 and through which heat from the cell 10 is transferred.

First, with reference to FIG. 2A, description will be given of how to set the configuration of the flat-shaped portion of each of the trays 1a and 1c itself.

In order to allow placement of the flat-shaped portion W xb×Wyb of the cell 10 thereon, the flat-shaped portion W xt×Wyt of each of the trays 1a and 1c is set as W xt>W xb and Wyt≧Wyb.

That is, the tray dimension W xt with respect to the x-axis direction is set to be larger than the corresponding dimension of the cell 10 to leave a margin for connecting the positive and negative electrode terminals 12a and 12b, and the dimension Wyt with respect to the y-axis dimension is set in conformity with the dimension Wyb with respect to the y-axis direction of the cell 10 so that the placement position of the cell 10 can be readily determined.

Further, when the thermal resistance of the portion of the flat-shaped tray 1a itself excluding the contact parts B is δta and the contact thermal resistance of the contact parts B at both ends of the tray 1a is δca, the thermal resistance δra of the thermal resistance path for the heat transferred from the tray 1a to the case 2 is represented by the following expression.
δra=δta+δca (1)

Likewise, the thermal resistance δra of the thermal resistance path of the tray 1c is represented by the following expression.
δrc=δtc+δcc (2)

Further, provided that the thermal conductivities of the two trays are the same, the thermal resistance δta and the thermal resistance δtc are represented as follows:
δta(=δtc)∝λ1/t (3)

Here, the tray 1a at the center portion of the laminate transports heat from both surfaces of the cell 10, and the tray 1c at an end of the laminate transports heat equal to the half of the heat transported by the tray 1a from one surface of the cell 10. Accordingly, in order to make equal (same) the amounts of heat transport per unit time from the two trays, it is necessary to make the amount of heat transport by the tray 1a twice as large as that by the tray 1c.

Therefore, in order to satisfy an equation δra×2≅δrc - - - (4), the thickness “t” of the tray 1a is made larger than that of the tray 1c so as to make the thermal resistance δta or the contact thermal resistance δca small.

Although either one of the thermal resistance δta and the contact thermal resistance δca may be varied, normally, the tray 1a and the tray 1c are formed so as to have the same thickness (δta=δtc), and the contact thermal resistance δca and contact thermal resistance δcc of the contact parts B, which will be described later in detail, are varied, thereby setting a predetermined thermal resistance in advance.

Next, the positioning part A will be described. The positioning part A is formed as follows. That is, as shown in, for example, FIG. 2A, each of the ends of the flap-shaped portion is bent at two opposing locations, and, as described above, the inside dimension W xt between the both ends is set to coincide with the dimension W xb with respect to the x-axis direction of the flat-shaped cell 10 within a predetermined dimensional tolerance, thereby allowing the placement position for the cell 10 to be readily determined as shown in FIG. 2B.

Then, as shown in FIG. 3, a plurality of such cells 10 are laminated to form the assembled battery 1.

Next, the structure of the contact part B will be described in detail. Now, referring to FIG. 4A again, each contact part B is composed of the contact portion B1 in contact with each of the opposing inner wall surfaces of the case 2 and the bent portion B2 to be brought into press contact therewith.

The contact part B is formed from a thin spring material such as an SUS, for example. The contact part B is brought into press contact with the inner wall surface of the case 2 with a predetermined contact pressure and is adapted so that the contact thermal resistance from the cell 10 to the case 2 does not change even in the event of positional variations of the tray 1a and tray 1b due to vibration or the like.

As regards the setting of the contact thermal resistance of the contact part B, the contact thermal resistance δca of the contact part B of the tray 1a is proportional to the product of the contact surface area “s” of the contact portion B1 and press contact force “p” thereof. Accordingly, although the setting of the contact thermal resistance can be easily performed by varying the contact surface area “s” of the contact portion B1 (or, by varying the contact surface area “s” by varying the number of the contact parts B1), the setting may be performed by varying either one of them.

Further, in order to make the contact thermal resistance of the contact part B small and stable, the contact thermal resistance is made small in advance by applying grease with good thermal conductivity to the contact part B or to the entirety of the tray 1a and tray 1b.

Further, a stable contact thermal resistance can be obtained by bringing the contact portion B1 into line contact with a small contact surface area.

Further, in order to vary the relative contact thermal resistances of the tray 1a and tray 1c, as shown in FIG. 4B, it is also possible to bond sealing compounds or sealants of different thermal conductivities to the respective contact portions B1 to thereby relatively adjust the thermal resistances of the tray 1a and tray 1c.

As has been described above, as regards the setting of the contact thermal resistances of the tray 1a and tray 1c, by making the contact thermal resistance smaller by at least either one of: increasing the contact surface area “s” of the contact portion B1 of the tray 1a at the central portion of the cell 10 surface; increasing the contact pressure of the contact portion B1; and increasing the number of the contact portions B1, or by making the contact thermal resistance larger by at least either one of: reducing the contact surface area “s” of the contact portion B1 of the tray 1c in the peripheral portion of the cell 10 surface; reducing the press contact force of the contact portion B1; and reducing the number of the contact portions B1; thereby varying the respective contact thermal resistance values to thereby make the amounts of heat release from the respective cells 10 uniform, thus suppressing variations in temperature thereof.

Further, the use of the tray 1a and tray 1c as described above facilitates the setting of the thermal resistance path and also facilitates the positioning operation performed at the time of assembling the cells 10.

Hereunder, referring to FIG. 1, description will be given of the lid member 5 and bottom member 6 which are provided in an opposed relation so as to sandwich the battery 1 from above and below.

The lid member 5 and the bottom member 6 are formed so as to be fitted in the inner dimension of the case 2, and a heat insulating material with low thermal conductivity, such as a hard urethane foam, for example, is used as the material thereof so that the heat of the laminated cells 10 is released only from the side wall surface of the case 2 via the tray 1a and the tray 1c.

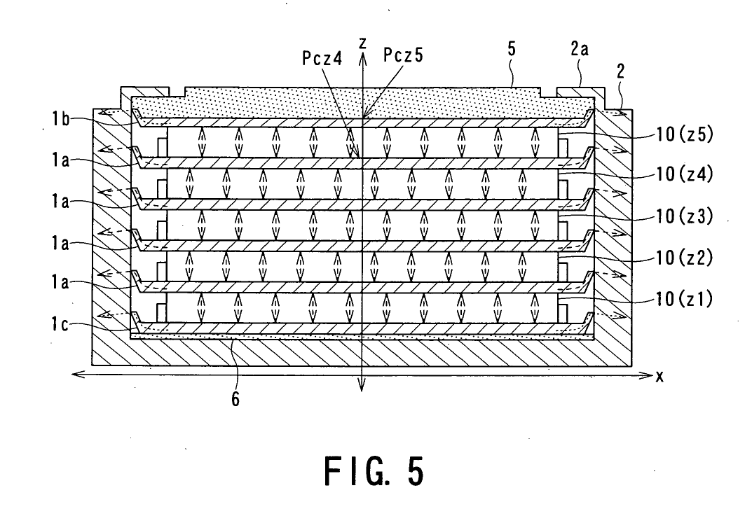

Further, the lid member 5 presses the surface of the laminate of the cells 10. In order to prevent positional displacement of each cell 10 within the case 2, the lid member 5 is bent at a position where the lid member 5 exerts a predetermined pressing force, for example, at the position of a deformation part 2a provided in the case 2 shown in FIG. 5, thereby effecting fixation.

Then, each of the positive and negative electrode terminals 12a and 12b and battery terminals 4a and 4b is formed into a predetermined configuration from a high-conductivity metal such as aluminum or copper and is fixed to the case 2 while being insulated from the case 2.

Further, the joining portions between the positive and negative electrode terminals 12a and 12b of the cells 10, and the joining portions between the battery terminals 4a and 4b and the positive and negative electrode terminals 12a and 12b of the assembled battery 1 are fused together by welding or the like, for example.

Next, referring to FIG. 5, description will be given of the thermal conduction action for suppressing temperature variations among the respective cells 10 within the case 2 constructed as described above.

FIG. 5 is a sectional view of the x-y plane taken along the central position of the case 2 of the battery pack and is a model view illustrating how heat from the central portion and end portions of each of the laminated cells 10 is released from the side wall of the case 2. The broken arrows for the tray 1a, tray 1b and tray 1c indicate the direction in which heat is conducted, and thickness of each arrow indicates the amount of heat.

The respective laminated cells 10 forming a five-layer laminate, the cells 10(z1) to 10(z5), are shown from the bottom in the order of lamination. As indicated by the broken arrows, the Joule heat and chemical reaction heat of the respective cells 10 are transferred to each of the trays 1a, 1b and 1c from the bottom and rear surfaces of the corresponding cells 10 and transferred to the inner wall of the case 2 via the contact parts B at the ends of the trays 1a, 1b and 1c before being released to the atmosphere from the outer wall surface of the case 2.

As for the heat conduction in the z-direction of the respective cells 10, the thermal insulation is effected by the bottom member 6 and the lid member 5 with respect to the direction toward the lower side of the cells 10(z1) and the direction toward the upper side of the cells 10(z5), respectively, in the directions toward the upper and lower sides, so that the heat is transferred to the case 2 via the trays 1b and 1c.

At the time of this thermal conduction, while in the x-axis direction and the y-axis direction with respect to the center of the cells 10 the same thermal resistance path is formed axisymmetrically with respect to the center of the cells 10, in the z-axis direction, the amount of heat conducted by the tray 1a placed at the central portion of the case 2 and the amount of heat conducted by the trays 1b and 1c are adapted to be different from each other.

That is, while the tray 1a conducts heat from both the upper and lower surfaces of the cell 10, the trays 1b and 1c each conduct heat from one of the front and back surfaces of the cell 10. Accordingly, the thermal resistance value of a predetermined thermal resistance path is set in advance so that the amount of thermal conduction by the tray 1a becomes larger than the amount of thermal conduction by each of the trays 1b and 1c.

According to the construction of this embodiment, the trays 1a, 1b and 1c conduct heat as described below from the central portion of each cell 10 to the inner wall surface of the case 2.

For instance, provided that the temperature at the central portion Pcz5 of the tray 1b at the central portion of the cell 10(z5) is θc5, and the temperature of the contact portion of the tray 1b with the inner wall surface of the case 2 is θw, the amount of heat Qcz5 conducted through the tray 1b per unit time is represented by the following expression.
Qcz5∝(θc5−θw)/δrb(=δtb+δcb) (5)

Here, δrb represents the thermal resistance of the thermal resistance path for the heat transferred from the tray 1b to the case 2, δtb represents the thermal resistance of the portion of the tray 1b excluding the contact part B, and δcb represents the contact thermal resistance of the contact part B at either end of the tray 1b.

Further, provided that the temperature at the central portion Pcz4 of the tray 1a at the central portion of the cell 10(z4) is θc4, and the temperature at the contact portion of the tray 1a with the inner wall surface of the case 2 is θw, the amount of heat Qcz4 conducted through the tray 1a per unit time is represented by the following expression.
Qcz4∝(θc4−θw)/δra(=δta+δca) (6)

Here, δra represents the thermal resistance of the thermal resistance path for the heat transferred from the tray 1a to the case 2, δta represents the thermal resistance of the portion of the tray 1a excluding the contact part B, and δca represents the contact thermal resistance of the contact part B at both the ends of the tray 1a.

Here, since the amounts of heat transported by the tray 1a and the tray 1b are represented as Qcz4>Qcz5 (7), in order to make equal the temperature at the central portion Pcz5 of the tray 1b and the temperature at the central portion Pcz4 of the tray 1a, that is, in order to satisfy the expression θc5=θc4, the following expression is to be satisfied:
Qcz5/Qcz4∝δra/δrc (8)

That is, the configurations of the trays 1b and 1a other than the respective contact parts B are made identical with each other so that δtb=δta, and the contact thermal resistance δcb and the contact thermal resistance δca of the respective contact parts B are set in advance so that the amounts of transport of heat (amounts of heat) conducted by the respective trays per unit time become equal, whereby the temperatures of the respective cells are made the same.

As has been described above, the thermal resistance of the tray 1a is set to be small, and the thermal resistance of the tray 1b is set to be large so that the ratios of thermal conductivity(=1/thermal resistance) of the thermal conduction paths of the respective trays, through which heat of each signal cell 10 is released from the surface of the case 2, become the same, thereby reducing temperature variations between the central portion Pcz5 of the cell 10(z5) and the central portion Pcz4 of the cell 10(z4).

Next, referring to FIG. 1 again, the fixing method for the battery pack according to this embodiment will be described. As shown in FIG. 1, to fix the battery pack in place, mounting holes 2h are provided at portions C of the lateral surfaces of the case 2 and at portions D of the bottom portion thereof, and the battery pack is directly fixed with screws.

That is, since the battery pack according to the present invention is constructed so as to minimize temperature variations between the respective cells 10 within the case 2, temperature non-uniformity between respective portions of the case 2 is reduced, thereby making it possible to fix the case 2 of the battery pack using the screws.

Further, the battery pack according to this embodiment exhibits good heat release property because the case 2 serves as the heat release portion, and variations in dimension due to the linear expansion of the battery pack are extremely small, whereby stress concentration at the screw-fixing portion of the case 2 can be avoided. As a result, the battery pack can be fixed in place with screws.

Further, since the case 2 serves as the heat release portion, as compared with heat transfer via air, the intimate fixation to a member such as a metal by fastening with the screws allows improved heat transfer and heat release characteristics to be attained.

Therefore, it is possible to provide a battery pack of an assembled battery that can be directly fixed to a heat release structure of a portable cordless device or an automobile.

### Second Embodiment

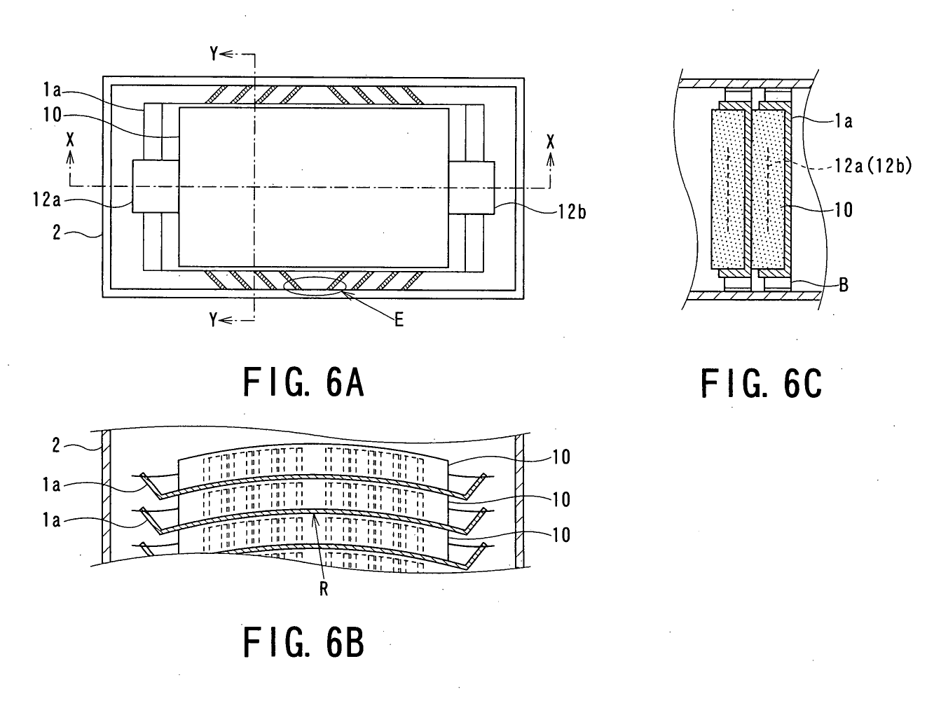

Hereinbelow, the second embodiment of the present invention will be described with reference to FIG. 6. The respective portions according to the second embodiment corresponding to those of the battery pack according to the first embodiment shown in FIGS. 1 to 5 are denoted by the same reference numerals and detailed description thereof will be omitted.

The second embodiment differs from the first embodiment in that while, in the first embodiment, the trays 1a, 1b and 1c are formed such that the portions thereof on which the respective cells 10 are placed, excluding the contact parts B, have the same flat-shaped configuration, in the second embodiment, the flat-shaped portion of each tray on which the cell 10 is placed is curved so as to have a curved configuration.

FIG. 6A is a plan view, as seen from above, of the battery pack excluding the lid member 5, FIG. 6B is a sectional view taken along the line VIB-VIB of FIG. 6A, and FIG. 6C is a sectional view taken along the line VIC-VIC of FIG. 6A.

The tray 1a according to the second embodiment is provided with eight contact parts 8 which are brought into press contact with the opposite inner wall surfaces of the case 2 with respect to the y-axis direction. A more stable contact thermal resistance can be obtained in the case of the line contact than in the case of the surface contact. In this embodiment, the requisite contact thermal resistance can be attained by increasing the number of contact parts B, whereby the contact parts B can be brought into line contact. Furthermore, since the contact parts B are formed by bending, each contact part B can also serve as a spring, thereby making it possible to reduce variations in the contact pressure of the contact part B with the case 2.

As described above, the tray 1a according to the second embodiment allows a reduction in variations of contact thermal resistance, thereby making it possible to prevent non-uniformity from occurring in the temperatures of the trays 1a due to the variations in thermal contact resistance. As a result, it is possible to prevent deterioration in performance from occurring due to the non-uniformity in temperature between the cells 10.

It should be noted that the present invention is not limited to the above-described embodiments and many other changes and modifications may be made without departing from the scopes of the appended claims.

For example, any tray provided with a positioning portion and a contact part for the cell may be used as the tray on which the cell is placed. Furthermore, any construction may be adopted as long as the temperatures of the laminated cells can be made the same by varying the thermal resistance paths constituted by the contact part between the surface of the cell and the tray, the tray, and the contact part between the tray and the case. In implementing the present invention, various modifications can be made to the configuration and material of the trays, and the structure of the contact part between each tray and the case in accordance with the configuration of each cell.

What is claimed is:

1. A battery pack comprising:
a plurality of flat-shaped cells each including a generator element sealed by a laminate film;
a case for accommodating the cells so as to be laminated in a thickness direction thereof, the case having an opening formed at least at one end thereof;
a lid member fixed to the opening of the case and pressing the laminated cells in a laminating direction thereof;
a bottom member provided between the case and the cell located at an end of the laminated cells on a side opposite to the opening of the case;
a first tray provided between the cells and brought into contact with the case;
a second tray provided between the lid member and the cells and brought into contact with the case; and
a third tray provided between the bottom member and the cells and brought into contact with the case,
wherein the lid member and the bottom member are formed of a material having a thermal conductivity lower than a thermal conductivity of any one of the first tray, the second tray and the third tray.

2. The battery pack according to claim 1, wherein the first tray is formed of a material having a thermal conductivity higher than a thermal conductivity of either one of the second tray and the third tray.

3. The battery pack according to claim 1, wherein the first tray has a thickness or a thickness-wise sectional configuration which is varied so that the first tray has a thermal resistance lower than a thermal resistance of either one of the second tray and the third tray.

4. The battery pack according to claim 1, wherein the case has a side wall to which a screw hole is provided.

5. The battery pack according to claim 1, wherein the case has a bottom portion to which a screw hole is provided.

6. The battery pack according to claim 1, wherein each of the first tray, the second tray and the third tray includes a contact part for guiding a placing position for each of the cells and contacting under pressure the cell to opposite inner wall surfaces of the case.

7. The battery pack according to claim 6, wherein the contact part of each of the first tray, the second tray and the third tray contacting the case is formed by a plurality of thin leaf springs which come into line or surface contact to an inner wall surface of the case, the contact part being bent toward the opening of the case for press contact.

8. The battery pack according to claim 6, wherein the contact part of each of the first tray, the second tray and the third tray to the case is formed by a plurality of thin leaf springs which come into line or surface contact to an inner wall surface of the case, the contact part being brought into press contact to the inner wall surface of the case.

9. The battery pack according to claim 6, wherein the contact part of each of the first tray, the second tray and the third tray to the case includes a plurality of thin leaf springs which are bent in different directions with respect to a direction orthogonal to the laminating direction of the cells.

10. The battery pack according to claim 6, wherein the contact part of each of the first tray, the second tray and the third tray to the case includes a fitting engagement part where the first tray, the second tray and the third tray come into fitting engagement with each other at least in one direction when laminated.

11. The battery pack according to claim 1, wherein each of the first tray, the second tray and the third tray is formed in a configuration curved in a thickness direction in which the cells are laminated.
